(19) United States
(12) Patent Application Publication
(10) Pub. No.: US 2006/0180955 A1
(43) Pub. Date: Aug. 17, 2006

(54) Spacer with stretchable sheath

(76) Inventor: Jean Girard, Brownsburg-Chatham (CA)

Correspondence Address: Jean Girard;c/o PROTECTIONS EQUINOX INT'L INC., Suite 224, 4480, Cote-de-Liesse, Montreal, QC, H4N 2R1, CA

(21) Appl. No.: 11/055,694

(22) Filed: Feb. 11, 2005

(51) Int. Cl. B28B 17/00

(52) U.S. Cl. 264/333; 249/160; 264/337

(57) ABSTRACT

A spacer maintains a structure in a spaced relationship relative to a mould inner surface surrounding structure and having a mould inner opening impermeably covered by a stretchable sheath. Stretchable sheath engages structure when a retaining force for retaining structure in spaced relationship is applied during introduction of a settable mixture into space to form a product therein. When retaining force is withdrawn, sheath is smoothly aligned with mould inner surface and smoothly bounds space therewith for forming product. By impermeably covering mould inner opening, sheath further prevents flow of settable mixture outside of space there through.

### FIELD OF THE INVENTION

The present invention relates to spacers for maintaining structures in a spaced relationship and is more particularly concerned with a spacer having a stretchable sheath.

### BACKGROUND OF THE INVENTION

Concrete pipe and similar reinforced products, such as manholes, box sections, catch basins, septic tanks and the like, are conventionally manufactured by positioning a reinforcing structure, such as a reinforcing metal mesh cage or the like, within an a first, outer mould. A settable mixture, such as concrete, is then distributed within the mould in a space bounded by a mould inner surface of the mould to form the product. For example, in a so-called dry cast process, a dry settable mixture is introduced into the mould and distributed therein by subjecting the settable mixture to heavy duty vibration, packing, or spinning. The mould is then removed. However, the structure must be retained in a fixed retaining position during the distribution in order to provide a product of sufficient strength and to ensure that parts of the structure are not unevenly placed within the product and that they do not protrude outwardly therefrom. This requires maintaining the structure within the space in a spaced relationship with regard to the mould inner surface of the outer mould during distribution of the settable material.

In order to maintain the spaced relationship, recourse is typically had to spacing means, commonly referred to as a spacer. Spacers are typically engaged upon the structure during distribution of the settable mixture and retain the structure in the retaining position with regard to the mould inner surface. Thus, the spaced relationship is maintained.

The aforementioned use of spacers in the manufacture of reinforced products is well known and a number of different spacers have been proposed in the prior art. For example, one or more spacers having outward protrusions can be attached to the structure prior to placement in the mould, the spacer being completely enclosed within the mould when the structure, with spacers installed, is within the mould. The outward protrusions of the spacer, which extend therefrom toward the mould inner surface, engage the mould inner surface when the structure is inserted therein and maintain the positioning of the structure and the spaced relationship.

U.S. Pat. No. 4,989,388 discloses such a spacer, where the spacer is formed of a continuous piece of round spring-steel wire and has a closed loop formed at one end that hooks on a wire of the structure, namely a metal mesh cage. The closed loop connects two parallel spaced-apart legs that provide a spacing nose, i.e. the outward protrusion, the legs terminating at the other end of the spacer in an S-shaped hook that snaps over another of the wires of the cage. The spacing nose engages the inner surface of the mould and maintains the spaced relationship. However, spacers of this nature often require manual placement of a significant number of spacers on the structure prior to insertion of the spacer in the mould. This is cumbersome, time consuming, and labour intensive, and therefore expensive. Further, the spacer remains permanently attached within the product, thereby engendering a risk that the spacer may protrude outwardly from one or more surfaces of the product, thus possibly impeding manufacture of a product having a smooth surface. In addition, the spacer can not be re-used, which further increases costs as new spacers must be used every time the mould is used to manufacture another product.

U.S. Pat. No. 5,236,322 discloses a re-usable spacer for a concrete pipe product making machine having a mould for forming the product, namely a concrete pipe. The spacer is installed on an outer surface of the mould, opposite the inner surface surrounding the structure, and has an extension means, namely a piston, for extending a retaining member, i.e. a blade, disposed in a cylinder assembly. The piston is connected to the blade and moves the blade through a passageway, defined by an outer opening on a mould outer surface of the mould and an inner opening on a mould inner surface of the mould, to a retaining position for retaining the structure in the desired spaced relationship and for retracting the blade into a retracted position in which the retaining member is integrally retracted from the space bounded by the mould inner surface after the distribution of the settable mixture. Since the retaining member is retracted and the spacer is not disposed on the inner surface of the mould, the spacer can be re-used. U.S. Pat. Nos. 4,710,115 and 4,505,658 also disclose re-usable spacers attached to the outer surface of the mould and that use retaining members inserted through a passageway to retain the metal mesh cage structure in position.

While the reusable spacers taught by U.S. Pat. No. 4,710,115, U.S. Pat. No. 5,236,322, and U.S. Pat. No. 4,505,658 at least partially address the question of re-use, they are vulnerable to the possibility that the settable material will flow into the mould inner opening, notably near the edges thereof, and thus outside the space bounded by the mould inner surface. Flow of the settable mixture outside the space though the mould inner opening may cause an uneven distribution of the settable mixture, especially around the mould inner surface, thereby engendering unwanted protrusions, such as ridges, on the surface of the product near the mould inner opening, especially when a smooth surface for the product is desired. Further, an uneven distribution of the settable mixture may create areas of relative weakness within the product, possibly reducing product life.

Accordingly, it would be advantageous to have a re-usable spacer that is easily and economically fastened to the mould on the mould outer surface thereof and which prevents flow of the settable mixture outside the space defined by the mould inner surface of the mould.

### SUMMARY OF THE INVENTION

The present invention provides a spacer and sheath therefor that furnish numerous advantages. Firstly, sheath advantageously prevents formation of ridges and allows for formation of a product having a smooth product outer surface, without ridges or other protrusions, defined by a first mould inner surface that surrounds a structure, such as a metal mesh cage, of a first mould and a sheath. In addition, the spacer is fastened to a first mold outer surface of the first mold and is thus re-usable. Further, the spacer has adjustment means for adjusting the spaced relationship of the structure in relation to the first mold inner surface.

In one aspect, the present invention provides a spacer for retaining a structure in a spaced relationship relative to a smooth first mould inner surface of a first mould, the first mould inner surface generally surrounding the structure and having a first mould inner opening extending at least partially inwardly into the first mould, during distribution of a settable mixture within a space within the first mould, the spacer comprises: a stretchable sheath for impermeably covering the first mould inner opening, the sheath stretching into the space towards the structure and retaining the structure in the spaced relationship when a retaining force for retaining the structure in the spaced relationship is, applied to the sheath, the sheath substantially smoothly aligning with the first mould inner surface to smoothly bound the space therewith when the retaining force is withdrawn for preventing a flow of the settable mixture outside the space through the first mould inner opening.

In another aspect, the present invention provides a stretchable sheath disposed between a retaining member of a spacer and an inner opening of an inner surface of an outer mould, the inner opening being impermeably covered by the sheath and extending at least partially inwardly into the outer mould, the sheath stretching and enveloping the retaining member when the retaining member is extended through the inner opening into a retaining position for retaining a structure in a spaced relationship relative to the inner surface during distribution of a settable mixture within a space within the first mould, the sheath being substantially aligned with the first mould inner surface and smoothly bounding the space therewith when the retaining member is integrally retracted from the space into a retracted position, the sheath preventing a flow of the settable mixture outside the space through the inner opening.

In still another aspect, the present invention provides a method for preventing flow of a settable mixture outside of a space within which a settable mixture is distributed while maintaining a spaced relationship of a structure relative to a first mould inner surface of a first mould, the first mould inner surface having a first mould inner opening extending at least partially into the first mould, the method comprises the steps of:
a) securely attaching a stretchable sheath to the first mould to impermeably cover the first mould inner opening;
b) subsequent to the attaching, extending a retaining member through the first mould inner opening into a retaining position to retain the structure in the spaced relationship;
c) subsequent to the extending, distributing the settable mixture within the space; and
d) before terminating the distributing, retracting the retaining member from the space into a retracted position outside the space, the sheath being smoothly aligned with the first mould inner surface and smoothly bounding the space therewith when the retaining member is in the retracted position, the sheath preventing a flow of the settable mixture outside the space through the first mould inner opening.

In all aspects, sheath impermeably covers inner opening and is smoothly aligned with first mould inner surface when retaining force and retaining member are withdrawn. Thus, sheath advantageously prevents formation of ridges and allows for formation of a product having a smooth outer surface, without protrusions such as ridges, defined by first mould inner surface and sheath.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is an outer perspective view of an embodiment of a spacer in accordance with a first embodiment of the present invention;

FIG. 2 is a side sectional view of the spacer shown in FIG. 1, showing the spacer fastened to a first mould;

FIG. 3 is a side sectional view of a spacer shown in FIG. 1, showing a plurality of spacers fastened to a first mould and circumferentially spaced thereupon;

FIG. 4 is an exploded view of the spacer shown in FIG. 1, from an outer perspective facing a fastening plate thereof;

FIG. 5 is an exploded view of the spacer shown in FIG. 1, from an inner perspective facing a sheath inner surface thereof;

FIG. 6 is an inner perspective view of the spacer shown in FIG. 1; and

FIG. 7 is a side perspective view of the spacer shown in FIG. 1, showing a plurality of spacers fastened in longitudinal alignment on a first mould.

### DETAILED DESCRIPTION OF THE PREFERRED EMBODIMENTS

With reference to the annexed Figures an embodiment of the present invention will be herein described for indicative purpose and by no means as of limitation. The invention in general will first be described and then an application of the invention for forming concrete products, including reinforced concrete pipes having reinforcing metal mesh cages contained therein, will be illustrated.

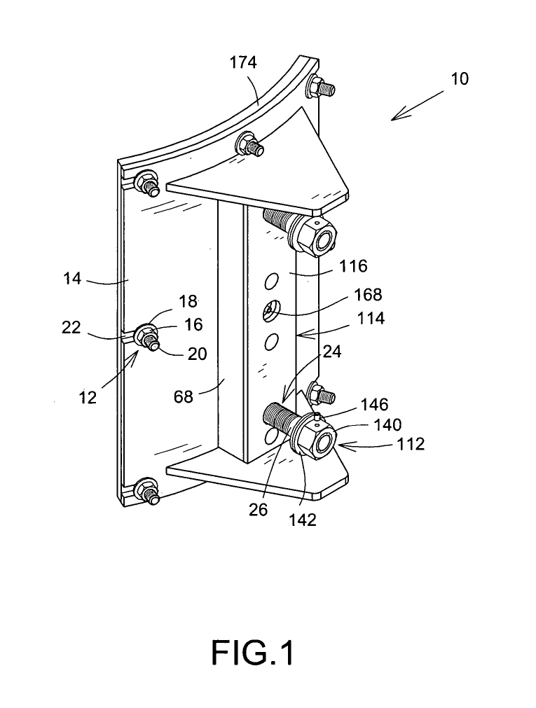

Referring now to FIG. 1, therein is shown an outer perspective view of a spacer in accordance with an embodiment of the present invention, shown generally as 10. Spacer 10 has fastening means, shown generally as 12, which, in the embodiment, includes a fastening plate 14 that is securely attached with fastening plate nuts 16 and fastening plate washers 18 to fastening plate screws 20 that engage correspondingly spaced notches 22 in fastening plate 14. Spacer 10 also has adjustment means, shown generally as 24, and which includes rods 26, for adjusting a spaced relationship maintained by spacer 10.

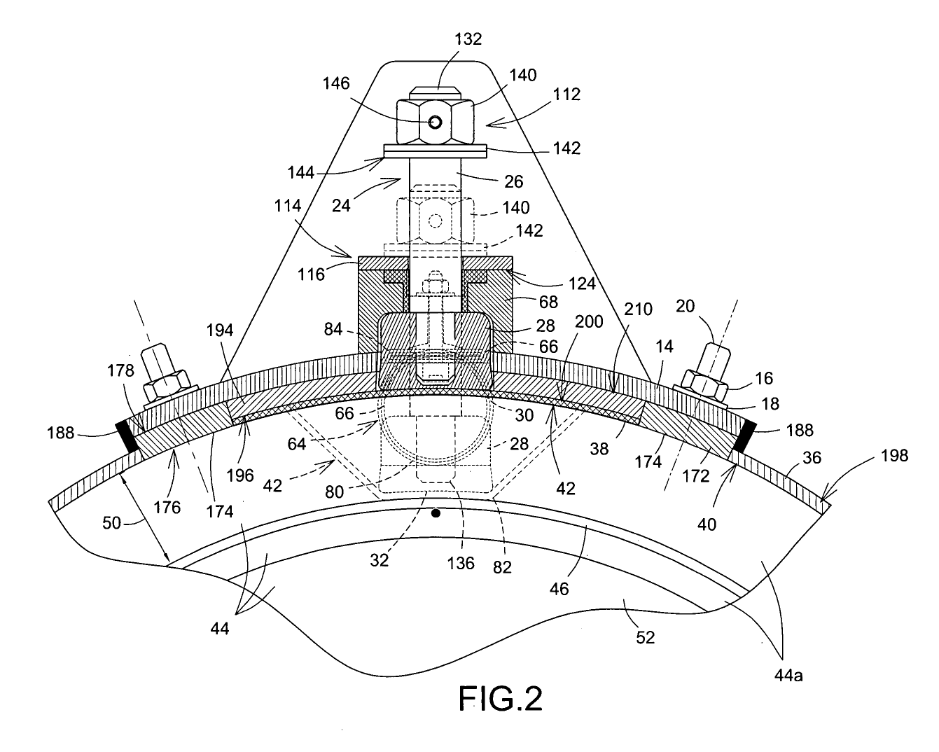

To generally explain the functioning of spacer 10, reference is now made to FIG. 1 and FIG. 2, a cross sectional view of spacer 10 shown in FIG. 1. Spacer 10 has retaining member 28 which is extendable from retracted position 30 to retaining position 32 through first mould inner opening 34, which extends into first mould 36. First mould inner opening 34 is impermeably covered by stretchable sheath 38 on first mould smooth inner surface 40 and, when sheath 38 is in retracted position 30, sheath inner surface is 42 smoothly aligned with first mould inner surface 40 and smoothly bounds space 44 therewith. A settable mixture (not shown), such as concrete or the like, is distributed into space 44 for forming a product, not shown, made from the settable mixture and having the shape of space 44. When in retracted position 30, retaining member 28 is integrally retracted from space 44 through first mould inner opening 34 and maintains sheath 38, and particularly sheath inner surface 42, in smooth alignment with first mould inner surface 40 across first mould inner opening 34. When extended into retaining position 32, retaining member 28, enclosed by sheath 38, is extended into space 44 by a retaining force which retaining member 28 in turn exerts on sheath 38, thereby stretching sheath 38, and on structure, shown generally as 46. Retaining force causes retaining member 28, and therefore sheath 38, to engage structure 46 and retain structure 46 in a spaced relationship 50 relative to first mould inner surface 40 to ensure that structure 46 is correctly situated in the product formed during distribution of the settable mixture and containing structure 46. Specifically, spaced relationship 50 refers to the distance between structure 46 and first mould inner surface 40.

Additional second mould 52 may be situated within space 44 and structure 46 between first mould inner surface 40 and second mould 52. Second mould may be so situated to form a product having a hollow inner portion defined by second mould 52 and an outer product portion, not shown, shaped in the form of reduced space 44a and containing structure 46 within outer product portion.

Sheath inner surface 42 is impermeable to settable mixture, as is first mould inner surface 40. Sheath covers first mould inner opening 34 at all times during distribution of settable mixture in space 44. Thus, sheath 38 impermeably separates retaining member 28 from space 44 when extended therein into retaining position 32 by retaining force, thereby enveloping retaining member 28, and when retaining member 28 is in retracted position 30. It will be apparent to one skilled in the art that sheath 38 and first mould 36 may also be constructed such that all portions of each are impermeable to settable mixture.

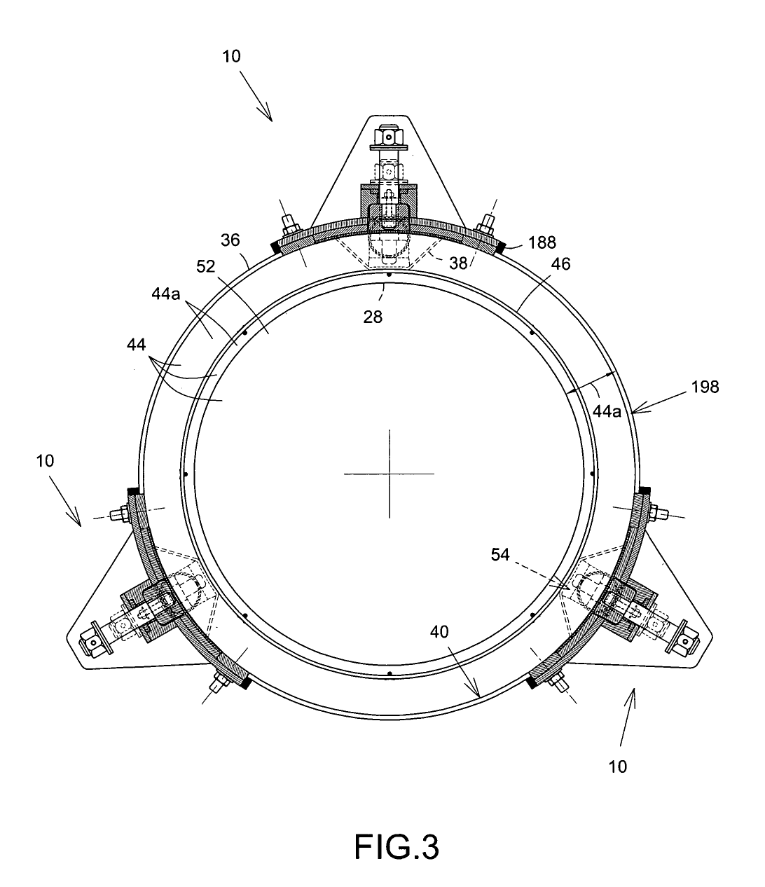

Reference is now made to FIG. 2 in conjunction with FIG. 3, a side sectional view of spacer 10 shown in FIG. 1, showing a plurality of spacers 10 fastened to first mould 36 and circumferentially spaced thereupon. When forming the product, retaining member 28, enveloped by sheath 38, is extended into retaining position 32 by retaining force and distribution of the settable mixture into space 44 is commenced. Retaining member 28 is maintained in retaining position 32 by retaining force until the settable mixture is sufficiently distributed in space 44 and sufficiently set to retain structure 46 in the spaced relationship 50 without further retaining by retaining member 28. Retaining member 28 is then retracted into retracted position 30 and sheath 38, specifically sheath inner surface 42, is smoothly aligned with first mould inner surface 40. The sheath inner surface 42 and first mould inner surface 40 thus form a smooth and impermeable moulding surface and smoothly and impermeably outwardly bound space 44.

Distribution of settable material continues during retraction into retracted position 30 and while retaining member 28 is situated therein until distribution of settable mixture in space 44 is complete, i.e. when settable mixture is distributed throughout space 44. Since sheath inner surface 42 is impermeable to settable mixture and smoothly aligned with first mould inner surface 40 when retaining member 28 is in retracted position 30, sheath 38 prevents flow of settable mixture outside of space 44 through first mould inner opening 34. Thus, sheath 38 prevents formation of protrusions, such as ridges, of settable mixture or uneven distribution of thereof in any part of space 44 situated adjacent to first mould inner opening 34. The smooth and impermeable characteristics of first mould inner surface 40 also prevent formation of protrusions and uneven distribution of settable mixture adjacent thereto. Thus, the product formed has the shape of space 44 and has a smooth outer product surface matching that of the first mould inner surface 40 and the sheath inner surface 42 which bound space 44. A possible distribution of a plurality of spacers during product formation is shown in FIG. 3.

Referring now to FIGS. 2, 3, and 4, as with first mould inner surface 40 and sheath inner surface 42, retaining member 28 has a smooth retaining member inner surface 54, which faces toward sheath 38. Since retaining member inner surface 54 is also smooth, retaining member inner surface 54 prevents formation of ridges in settable mixture in any part of space 44 adjacent thereto, including when retaining member 28 is retracted into retracted position 30. In contrast, retaining member outer surface 56, situated generally opposite retaining member inner surface 54 and facing away from sheath 38, has retaining member protrusions 58 extending outwardly therefrom in a direction away from sheath 38. Retaining member protrusions 58 are situated on generally latitudinally opposite retaining member ends 60, which bound retaining member central portion 62 of retaining member outer surface 56.

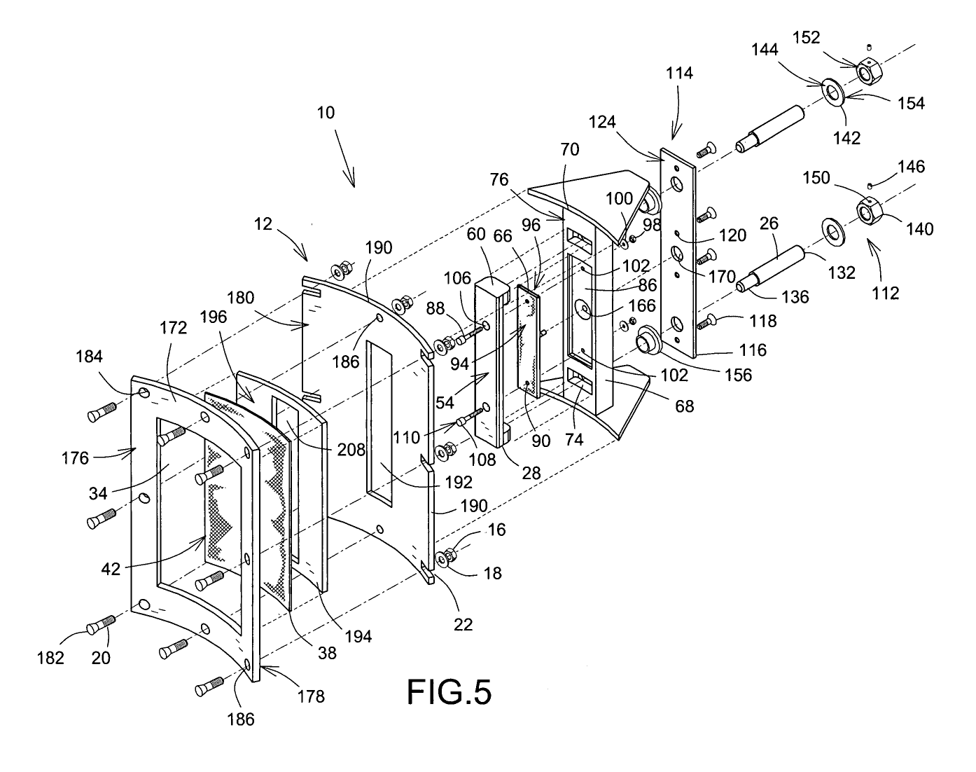

To show the details of the inner workings of spacer 10 and interconnecting parts thereof, reference is now made to FIGS. 2, 4, and 5. Extension of retaining member 28 into retaining position 32 is effected by extension means, shown generally as 64, which generates and applies retaining force to retaining member 28 and sheath 38 to retain structure 46 in spaced relationship 50. In the embodiment, extension means 64 is an air inflatable bladder 66 fixedly mounted and enclosed in housing 68, which is immovably and fixedly mounted within spacer 10. Specifically, housing 68 is mounted on fastening plate outer surface 72 of fastening plate 14 with housing base-ends 70 that are immovably and fixedly connected to fastening plate outer surface 72. When retaining member 28 is in retracted position 30, retaining member 28 is also situated in housing 68, with retaining member protrusions 58 engaged in retaining member protrusion sockets 74. Retaining member protrusion sockets 74 are disposed on housing top inner surface 76, which faces bladder 66 and retaining member 28, and extend at least partially into housing top 78. It will be apparent to one skilled in the art that a variety of means, such as solder, screws, or the like may be employed for connecting housing 68 to fastening plate outer surface 72 and it is not the intention of the inventor to impose any specific means or method therefor.

When in an extended configuration 80, i.e. when the bladder 66 is inflated with air, bladder 66 applies the retaining force upon retaining member 28 that is directed toward structure 46. The retaining force, generated by the expansion of bladder 66 by inflation thereof, extends retaining member 28 into retaining position 30 and, since retaining member 28 is separated from space 44 by sheath 38, causes sheath 38 to stretch into stretched configuration 82 as retaining member 28 moves into retaining position 32. Retaining member 28 is retained in retaining position 32 by the retaining force, and sheath 38 remains stretched in stretched configuration 82 engaging structure 46 until bladder 66 is placed in retracted configuration 84, i.e. when bladder 66 is deflated, thus withdrawing the air and the retaining force. As the retaining force is withdrawn, sheath 38 is no longer held in stretched configuration 82 thereby and contracts towards first mould inner surface 40, thereby applying a retracting force, directed away from space 44, upon retaining member 28 that causes retaining member 28 to retract back into retracted position 30.

Referring still to FIGS. 2, 4, and 5, bladder 66 is shaped and sized to be engaged in a bladder cavity 86, extending from housing top inner surface 76 into housing top 78, when bladder 66 is in retracted configuration 82. Bladder 66 is fixedly and sealably mounted in housing 68 upon threaded bladder screws 88 extending from retaining member central portion 62 through axially aligned bladder screw slits 90. Bladder screw slits 90 are situated on generally latitudinally opposite bladder ends 92 of bladder 66 on first bladder surface 94, facing retaining member 28, and generally opposite second bladder surface 96 Threaded bladder nut 98 and bladder washer 100 are mounted upon bladder screws 88 and bladder nut 98 is turned thereupon towards second bladder surface 96 to securely and sealably engage bladder washer 100 therebetween upon second bladder surface 96, thus attaching bladder 66 to retaining member 28 and mounting bladder 66 in housing 68. Bladder screw receiver slots 102, extending from housing top inner surface 76 and through housing top 78, are axially aligned with bladder screw slits 90 and bladder screws 88 and are sized and shaped to receive bladder screws 88, bladder nuts 98, and bladder washers 100 when retaining member 28 is returned to retracted position 30. As shown, bladder screw 88 may be removably engaged in a bladder screw socket 106 sized and shaped to engage bladder screw head 108. Bladder screw sockets 106 extends through retaining member 28 and are in axial alignment with bladder screw slits 90 and bladder screw receiver slots 102 and allows bladder screws 88 to extend therethrough. Further, each bladder screw socket 106 and bladder screw head 108 are sized and shaped such that, when bladder 66 is attached with bladder screw 88, bladder screw head inner surface 110, which faces sheath 38, is smoothly aligned with retaining member inner surface 54 and does not extend outwardly or inwardly therefrom. Alternatively, bladder screws 88 may be permanently and fixedly incorporated into central portion 62 of retaining member 28.

It will be apparent to one skilled in the art that use of other extension means 64 is possible. For example, bladder 66 could be inflated with water or could be motorized. In addition, other means than bladder screws 88, bladder nuts 98, and bladder washers 100, such as glue or sealant, may be contemplated for mounting extension means 64, whether extension means 64 is -a bladder 66 or not, in spacer 10. It is not the intention of the inventor to limit the extension means 64 and the means used for mounting the extension means 64 to those described specifically herein. It will be further apparent to one skilled in the art that other means than retaining member 28 may be used to apply retaining force to sheath 38 and structure 46. It is not the intention of the inventor to limit the means by which retaining force may be transferred and applied upon sheath 38 and structure 46 to the retaining member 28 disclosed herein.

Referring again to FIGS. 2, 4, and 5, to ensure that retaining position 32, and therefore the spaced relationship 50, can be adjusted, spacer 10 also has adjustment means, shown generally as 24. In the embodiment, adjustment means 24 is comprised of axially movably mounted rods 26 attached to retaining member 28 and having stopper means 112. More specifically, each rod 26 is axially movably mounted in barrier means 114, which is a housing top barrier plate 116 securely mounted upon housing top outer surface 104. Barrier plate 116 is mounted upon housing top outer surface 104 with threaded barrier plate screws 118 inserted through barrier screw openings 120 and extending from barrier plate outer surface 122 through barrier plate inner surface 124 and removably and securely engaged in threaded barrier screw sockets 126 disposed in housing top 78. Barrier plate inner surface 124 faces housing top outer surface 104 and is generally opposite barrier plate outer surface 122.

Barrier plate 116 has barrier plate rod openings 128 extending therethrough and into which rods 26 extend into housing 68 and which are axially aligned with housing rod channels 130 extending through housing top 78, from housing top outer surface 104 through retaining member protrusion sockets 74 and housing top inner surface 76. Rod 26 is axially and movably mounted through barrier plate rod openings 128 and housing rod channels 130, and rods 26 are engaged at a longitudinal first rod end 132 of each rod 26 in rod sockets 134 on retaining member 28. Thus, first rod end 132 is attached to retaining member 28. Longitudinal second rod end 136, which -is generally opposed to first rod end 132, has stopper means, generally shown as 112, mounted thereupon. Barrier plate 116 and housing top 78 are thus situated between retaining member 28 on first rod end 132 and stopper means 112 on second rod end 136.

In the embodiment, stopper means 112 is a threaded movable adjustment nut 140 and adjustment washer 142 adjustably movably mounted on second rod end 136, which is also threaded. Adjustment washer 142 is situated between adjustment nut 140 and barrier plate outer surface 122 of barrier plate 116. Each rod opening 128 in barrier plate 116 is of smaller dimension than adjustment washer 142. Thus, adjustment washer 142 prevents passage of adjustment washer 142 and adjustment nut 140 through rod opening 128, and, therefore, through barrier plate outer surface 122 when adjustment washer 142, specifically adjustment washer abutting surface 144 thereof, abuttingly engages barrier plate outer surface 122 towards which adjustment washer abutting surface 144 faces. Thus, barrier plate 116 serves as a barrier preventing passage of adjustment washer 142 and adjustment nut 140 through barrier plate outer surface 122 towards sheath 38; the passage being stopped by adjustment nut 140 and, more specifically, adjustment washer 142 which abuttingly engage barrier plate 116.

Threaded retaining screw 146 securely and releasably retains adjustment nut 140 in an adjustable adjustment position 148 corresponding to retaining position 32 of retaining member 28 when retaining screw 146 is engaged in threaded retaining screw socket 150. When retaining screw 146 is at least partially disengaged from retaining screw socket 150, adjustment nut 140 may be moved by turning adjustment nut 140 to adjust adjustment position 148 thereof.

When retaining member 28 is moved toward retaining position 32, first rod end 132 also moves toward retaining position 32 and second rod end 136 moves toward barrier plate outer surface 122. Adjustment position 148 of adjustment nut 140 is set such that, when retaining member 28 is in retracted position 30, a first distance D1, not shown, between adjustment nut abutting surface 152, facing adjustment washer 142, of adjustment nut 140 and housing barrier plate outer surface 122 is equal to a second distance D2, not shown, between retracted position 30 of retaining member 28 and retaining position 32 with addition of third distance D3, not shown. Third distance D3 is the distance between adjustment washer abutting surface 144 and generally opposite adjustment washer outer surface 154. In other words, when the second distance between retracted position 30 and retaining position 32 is D2, the adjustment position 148 of adjustment nut 140 is set to respect the following relationship, R1, for D1.
D1=D2+D3 (R1)

If the adjustment washer 142, which is optional provided that adjustment nut abutting surface 152 is of greater dimension than rod openings 128, is not used, then adjustment position 148 of adjustment nut 140 is set to make first distance D1 and second distance D2 equal. In other words, the relationship between D1 and D2 is defined by the following relationship R2.
D1=D2 (R2)

Thus, when retaining member 28 is moved to retaining position 32, adjustment washer abutting surface 144 abuttingly engages barrier plate outer surface 122 preventing further movement of retaining member 28 into space 44 in the direction of structure 46. Alternatively, if adjustment washer 142 is not used, adjustment nut abutting surface 152 accomplishes this task. Thus, the retaining member 28 is stopped at retaining position 32. By adjusting the adjustment position 148 of adjustment nut 140, the first distance D1 can be increased or reduced, thus allowing for a corresponding increase or reduction in the second distance D2 between retracted position 30 and retaining position 32. Since retracted position 30 is fixed, adjustment of adjustable position of adjustment nut therefore increases or decreases the extension of retaining member 28 into space 44 when in retaining position 32, thereby adjusting the retaining position 32 and spaced relationship 50.

To ensure that movement of rods 26 is substantially axially aligned with structure 46 and rod openings 128, spacer 10 has rod guiding means, namely an insertable rod guide socket 156 inserted in rod channel 130. Rod guide socket outer surface 158 is sized and shaped to securely and removably engage rod channel inner surface 160, thus holding rod guide socket 156 in rod channel 130 and allowing removal of rod guide socket 156 therefrom when barrier plate 116 is removed. Rod guide socket inner surface 162, disposed generally opposite rod guide socket outer surface 158 is sized and shaped to substantially align with size and shape of rod 26 and allow rod to move therein in axial alignment with structure 46 and rod openings 128, thereby keeping movement of rod 26 and retaining member 28 between retracted position 30 and retaining position 32 essentially straight and in axial alignment with rod openings 128.

Inflation of bladder 66 is effected via inflation means, shown generally as 164, externally accessibly disposed in an inflation means socket 166 which extends integrally through housing top 78. In the embodiment shown, inflation means 164 is an air valve 168 for receiving air that is externally accessible in inflation means socket 166 from inflation means opening 170 in barrier plate 116 that is axially aligned with inflation means socket 166. When air valve 168 is in an open configuration, not shown, air may be introduced thereby into bladder 66, for inflating bladder 66 into extended configuration 80, thereby generating and applying retaining force, or removed thereby from bladder 66, for deflating bladder 66 into retracted configuration 84, thereby withdrawing retaining force. Typically, to inflate bladder 66, air is introduced by connecting an air pump, not shown, to air valve 168, placing air valve 168 in the open configuration, and pumping air through air valve 168 into bladder 66. To deflate bladder 66, air pump is deactivated or removed and air valve 168 is placed in open configuration. When valve is in closed position, not shown, air is retained in bladder 66 and may not pass through air valve 168. Typically, air valve 168 will be in closed position when bladder 66 is inflated into extended configuration 80 to maintain retaining member 28 in retaining position 32.

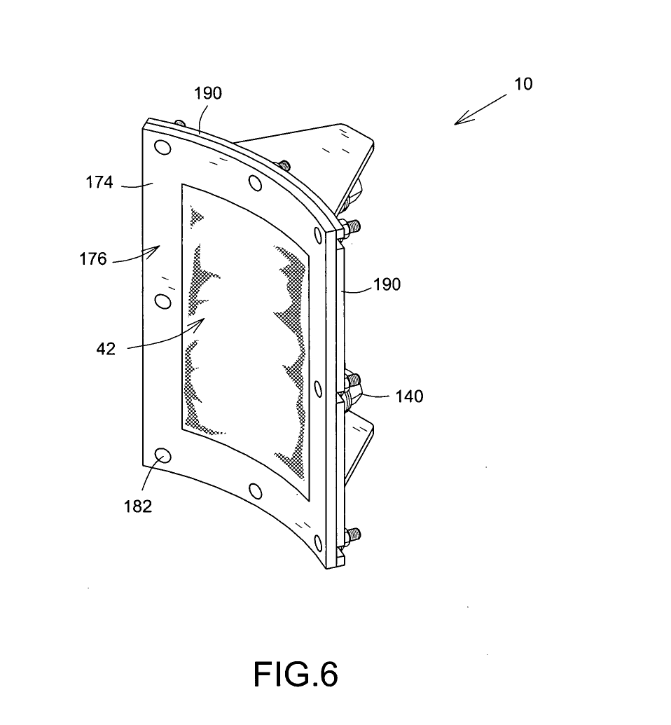

To better explain fastening of spacer 10 to first mould 36, reference is now made to FIGS. 2, 4, 5, and 6. As mentioned previously, spacer 10 is releasably fastened to first mould 36 with fastening means 12, namely fastening plate 14, with fastening plate screws 20 engaged in correspondingly spaced notches 22 of fastening plate 14. Threaded fastening plate nuts 16 and fastening plate washers 18 are engaged upon fastening plate screws 20 and fastening plate nuts 16 are turned towards fastening plate outer surface 72 adjacent to notches 22 for secure engaging fastening plate nuts 16 and washers 18 thereupon. Fastening plate 14 to is thus fastened to first mould 36 upon first mould outer surface 198, which is disposed generally opposite first mould inner surface 40. Fastening plate 14, and therefore spacer 10, can be removed by at least partially disengaging fastening plate nuts 16 by turning them away from fastening plate 14.

Fastening plate screws 20 protrude outwardly from first mould 36 beyond first mould outer surface 198 and are securely engaged in insert plate 172, which is fixedly inserted or otherwise incorporated into first mould 36 and securely attached therein by soldering or other methods in insert plate opening 174 in first mould 36. Insert plate inner surface 176, which faces space 44 and defines first mould inner opening 34 when insert plate 172 is inserted into insert plate opening 174, is smooth and is shaped to'smoothly align with first mould inner surface 40 and sheath 38 and smoothly and impermeably bounds space 44 therewith by forming part of the smooth and impermeable moulding surface. Insert plate outer surface 178, disposed generally opposite insert plate inner surface 176, is sized and smoothly shaped to smoothly align with the shape of first mould outer surface 198 and fastening plate inner surface 180. Fastening plate screws 20 have fastening plate screw heads 182 which are engaged in fastening plate screw sockets 184 having fastening plate screw openings 186 disposed on insert plate inner surface 176. Fastening plate screw heads 182 are sized and shaped to smoothly align with smooth lower insert plate surface and smooth inner surface when inserted into fastening plate screw openings 186 and insert plate inner surface 176. Thus, insert plate inner surface 176 and fastening plate screws 20 do not cause extrusions from the space 44 or protrusions into space 44 and smoothly bound space 44 along with first mould inner surface 40 and sheath 38.

To assist placement of fastening plate 14 on first mould outer surface 198, first mould outer surface 198 has protruding lips 188 attached thereto which are shaped for aligning with corresponding fastening plate edges 190 of fastening plate 14. When corresponding edges 190 are aligned with protruding lips 188, fastening plate screws 20 are aligned with correspondingly spaced notches 22 such that fastening plate screws 20 protrude through notches 22 for engagement with fastening plate nuts 16 and fastening plate washers 18. Fastening plate 14 also has fastening plate opening 192 extending through fastening plate inner surface 180 and which is sized and shaped to the contour of retaining member 28, thereby allowing retaining member 28 to pass from housing 68 through fastening plate 14 into space 44.

It will be apparent to one skilled in the art that fastening plate screws 20 may be directly incorporated into first mould 36 without use of insert plate 172. However, in such cases, fastening plate screws 18 must be incorporated into first mould 36 such that fastening plate screws 20 do not create protrusions into or extrusions from first mould inner surface 40 to ensure that space 44 remains smoothly bounded. Similarly, first mould inner opening 34 may be directly disposed in first mould inner surface 40 and defined therein without use of insert plate 172. It is not the intention of the inventor to limit the means by which fastening plate screws 20 may be incorporated into first mould 36 or to limit fastening means 12 to the fastening plate 14 shown and described herein. It is also not the intention of the inventor to limit the means in which first mould inner opening 34 may be defined to inclusion thereof in insert plate 172.

It will further be apparent to one skilled in the art that other means than fastening plate screws 20, such as clamps, may be used to fasten fastening plate 14 to first mould 36 and that, depending on the shape and the size of first mould 36 and fastening plate 14, one fastening plate screw 20 and one correspondingly spaced notch 22 may be sufficient for fastening spacer 10 to first mould 36. Also, again depending on size and shape of spacer 10 and first mould 36, a single protruding lip 188 may be sufficient for aligning fastening plate screws 20 with correspondingly spaced notches 22. Similarly, a single rod 26 may also be sufficient for adjustment of retaining position 32 and spaced relationship 50.

One skilled in the art will also note that other means than correspondingly spaced notches 22, such as closed sockets, may be used for engagement of fastening plate screws 20. It is not the intention of the inventor to limit the configuration of the fastening plate 14 to that shown and described herein. Finally, one skilled in the art will realize spacer 10 may be directly and fixedly incorporated into first mould 36.

Optional back plate 194 is removably insertable into first mould 36 and provides additional support and contouring for maintaining alignment of sheath inner surface 42 with shape of first mould inner surface 40 and, when insert plate 172 is present, insert plate inner surface 176. Back plate inner surface 196 faces space 44 and sheath 38 and is smoothly shaped and sized to smoothly engage sheath outer surface 200 which is disposed generally opposite sheath inner surface 42. More specifically, back plate 194 is removably inserted into first mould outer opening 202 which is aligned in shape and size with first mould inner opening 34 and generally disposed opposite thereto. Thus retaining member 28 may pass through first mould outer opening 202 and then through first mould inner opening 34, the two openings 34, 202 essentially forming a retaining member channel, not shown, to extend into retaining position 32. Sheath 38 is inserted through first mould outer opening 202 to impermeably cover first mould inner opening 34. When back plate is inserted into first mould outer opening 202, back plate inner surface 196 is located at an offset position, not shown, that is outwardly offset, towards first mould outer surface 198, from first mould inner surface 40 and insert plate inner surface 176 at a distance equal to the thickness of sheath 38. Thus, back plate inner surface 196 smoothly reinforces sheath 38 across first mould inner opening 34 in the contour and shape of first mould inner surface 40 and insert plate inner surface 176. Back plate 194 thereby ensures that sheath inner surface 42 remains in smooth alignment with first mould inner surface 40 and, when insert plate 172 is present, insert plate inner surface 176 while impermeably covering first mould inner opening 34.

Back plate 194, when inserted into first mould outer opening 202 and fastening plate 14 is fastened upon first mould 36, is situated between fastening plate 14 and first mould inner opening 34. When fastening plate 14 is removed, back plate 194 may be removed, allowing inspection, adjustment, and replacement of sheath 38.

Back plate 194 has back plate opening 208 through which retaining member 28 may pass. Thus, retaining member 28 may pass through first mould inner opening 34, or a portion thereof, i.e. back plate opening 208 when back plate 194 is inserted. Back plate opening 208 is axially aligned with fastening plate opening 192 and, like fastening plate opening 192, is sized and shaped to closely match the size and shape of retaining member 28. Further, fastening plate opening 192 and back plate opening 208 are positioned to be axially aligned with each other and with rod openings 128 and rod guide socket 156. Thus, fastening plate opening 192 and back plate opening 208 provide a retaining member guiding means for further facilitating maintenance of movement of retaining member 28 in axial alignment with rod openings 128.

Sheath 38 may be sealingly and impermeably attached to back plate 194 by a sealing agent such as a polyurethane compound, or may be directly attached to the edges of first mould inner opening 34. Alternatively, sheath 38 may be held in place by force applied by fastening plate 14 upon back plate 194 when fastening plate 14 is fastened to first mould 36. Sheath 38 may also be larger than back plate 194 and have a portion extending outside of first mould outer opening 202 when back plate 194 is inserted. This excess portion may be held between fastening plate inner surface 180 and back plate outer surface 210, generally opposed to back plate inner surface 196, when fastening plate 14 is fastened to first mould 36. It will be apparent to one skilled in the art that sheath may be directly attached to mould without use of back plate 194 or that other means than back plate 194 may be used for reinforcing sheath. It is not the intention of the inventor to limit the scope of the invention to use of backplate 194 as described herein.

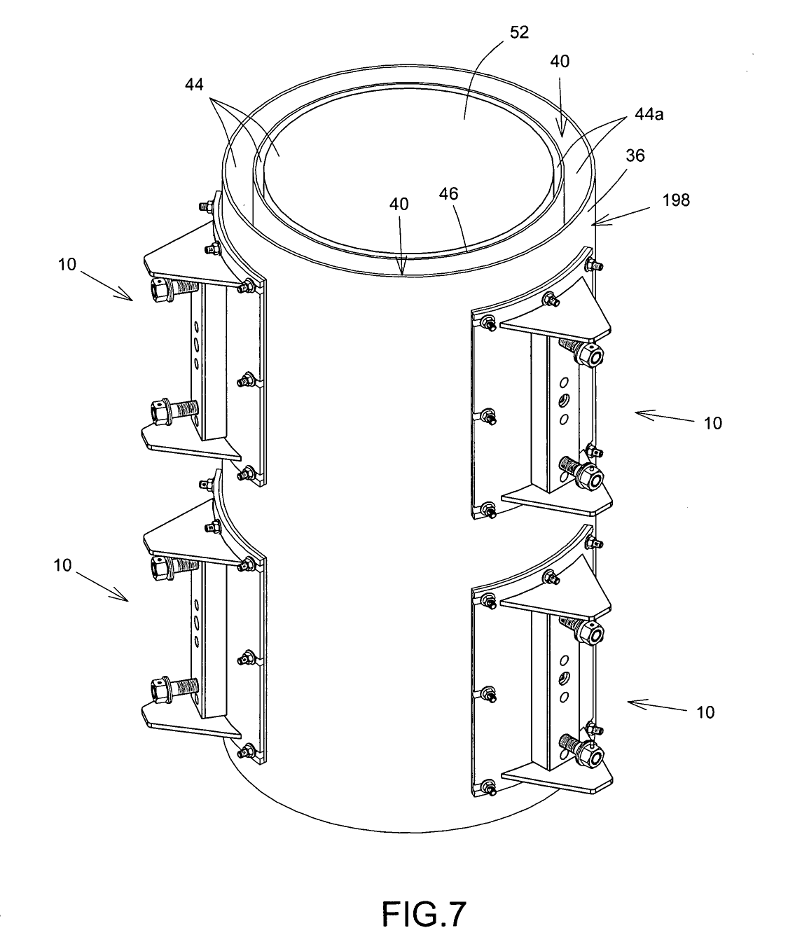

Referring now to FIGS. 2, 3, and 7, an application of spacer 10 for forming a reinforced concrete products, such as a concrete pipes, having reinforcing metal mesh cage as structure 46 is now described. As shown, a plurality of spacers 10 are fastened to first mould 36, using fastening plate screws 20, engaged in notches 22 on fastening plate 14, fastening plate washers 18 and fastening plate nuts 16. During fastening with fastening plate 14 for each spacer 10, protruding lips 188 facilitate alignment of fastening plate screws 20 with correspondingly spaced notches 22.

Once spacers 10 are fastened to first mould 36 and metal mesh cage, i.e. structure 46, is placed within reduced space 44a, retaining member is extended into space 44 by extension means 64 which is placed in extended configuration 80. In other words, bladder 66 is inflated, perhaps with an air pump, not shown, using air valve 168 in open configuration as inflation means 168. Inflated bladder 66 in extended configuration 80 applies a first force directed towards structure 46, metal mesh cage, that extends retaining member 28 into retaining position 32 and stretches sheath 38 into stretched configuration 82. Air valve 168 is then placed in closed position to retain air in bladder 66 and retain retaining member 28 in retaining position 32. When all spacers 10 have retaining members 28 in retaining position 32, structure 46, i.e. metal mesh cage, is securely retained in spaced relationship 50 in space 44 with regard to first mould inner surface 40. Distribution of settable mixture, i.e. concrete, is then initiated. When concrete is sufficiently distributed and set to maintain structure 46 in spaced relationship 50 without retaining by retaining member 28, extension means 64 is placed in retracted configuration 84. In other words, air valve 168 is placed in open configuration and air is allowed to escape from bladder 66 thereby, thus deflating bladder into retracted configuration 84. First force is therefore withdrawn and a second force, directed towards first mould inner surface 40 moves retaining member 28 back into retracted position. Distribution of concrete continues until concrete is completely distributed within space 44. Space 44, when retaining member 28 is in retracted position 30, is smoothly outwardly bounded by first mould inner surface 40 and sheath inner surface 42, as well as, when insert plate 172 and back plate 194 are present, insert plate inner surface 176 and back plate inner surface 196, all surfaces 40, 42, 176, 196 forming a smooth moulding surface. Further, sheath 38 prevents flow of concrete outside of space 44 through first mould inner opening 34. Thus, when distribution of concrete is completed and concrete is sufficiently set, the concrete product so formed has a smooth outer concrete product surface formed by surfaces 40, 42, 176, 196. In particular, outer concrete product surface is smooth and without uneven ridges in any part of outer concrete pipe surface area in proximity to first mould inner opening 34.

Should the desired concrete product require a hollow section, such as in the case of a reinforced concrete pipe, additional second mould 52 is inserted prior to distribution of concrete and surrounded by structure 46, i.e. the metal mesh cage. Second mould 52 therefore defines hollow portion of concrete pipe and concrete is distributed within reduced space 44a. Second mould 52 also has a smooth surface, thus insuring that the inner concrete surface of the product, i.e. the reinforced concrete pipe, formed thereby is also smooth.

For distributing concrete, a variety of methods and means may be employed, including vibration of concrete, packerhead techniques for packing concrete in space 44, or spinning. In addition, concrete may be substantially dry, such as is used in dry cast production of concrete products, or wet. It is not the intention of the inventor to limit the scope of the present invention to a given distribution method for any given settable mixture.

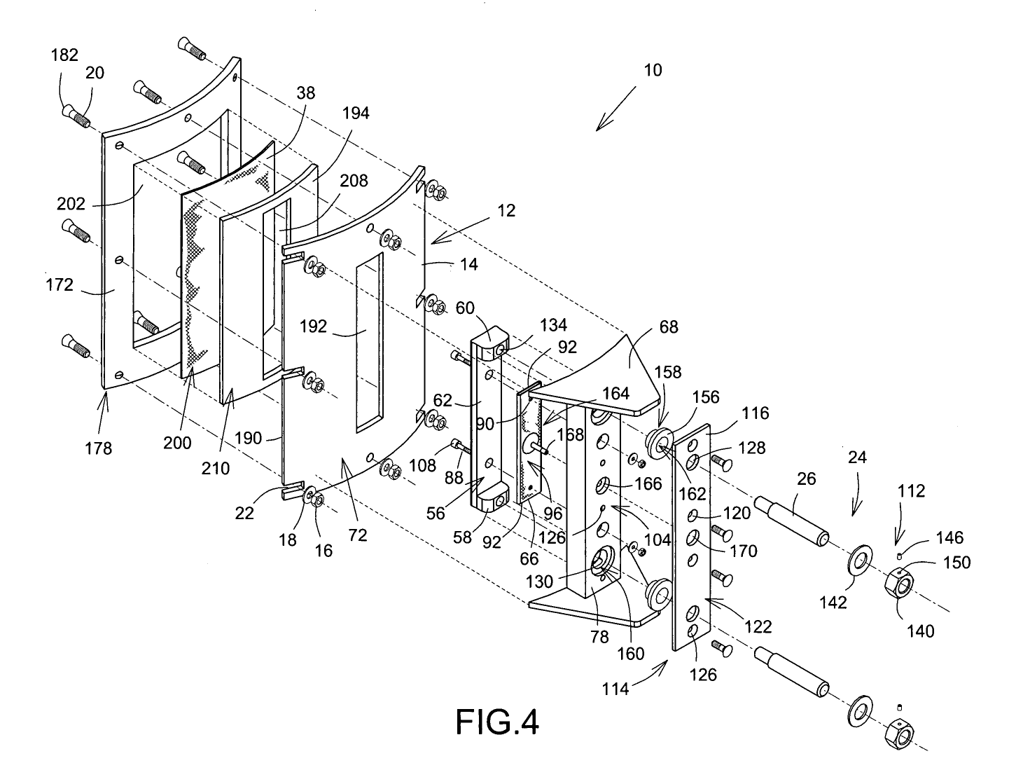

To show a possible distribution of spacers for manufacturing a reinforced concrete product as described above, reference is again made to Referring to FIGS. 3 and 4. As shown in FIG. 3, for a product of ovular shape, such as concrete pipe, using a first mould 36 having an ovular first mould inner surface 40 and an ovular first mould outer surface 198, a plurality of spacers 10 may be equally circumferentially spaced on first mould outer surface 198. Also, as shown in FIG. 4, a plurality of spacers 10 may be placed in longitudinally aligned on first mould outer surface 198. However, it will be apparent to one skilled in the art that the quantity of spacers 10 required and their exact placement will depend on the size and shape of the product. In general, the quantity of spacers 10 required will increase with the size of the product. Further, spacers 10 will be placed more closely together for smaller products. The respective shapes of the product, first mould inner mould surface 40, and first mould outer surface 198 will also influence the quantity of spacers 10 and their placement. It is not the intention of the inventor to limit the quantity and placement of spacers 10 to that specifically illustrated therein.

One skilled in the art will also realize that the settable mixture used need not be concrete. In fact, spacer 10 may be used in the forming of any product containing structure 46 in which a settable mixture is introduced into space 44 to form the product. For example, product could also be a plastic pipe or product. Finally structure 46 need not be a metal mesh cage, but may be any structure that must be contained in a product made of a settable mixture formed -in a space 44. It is not the intention of the inventor to limit the scope of the invention to any specific application, such as the manufacture of concrete pipes as described herein. Further, it is not the intention of the inventor to limit the settable mixture to any specific materials, such as concrete, or to limit the structure contained in the product to any specific structure, such as a metal mesh cage.

While specific embodiments have been described, those skilled in the art will recognize many alterations that could be made within the spirit and scope of the invention, which are defined solely according to the following claims.

I claim:

1. A spacer for retaining a structure in a spaced relationship relative to a smooth first mould inner surface of a first mould, the first mould inner surface generally surrounding the structure and having a first mould inner opening extending at least partially inwardly into the first mould, during distribution of a settable mixture within a space within the first mould, said spacer comprising:
a stretchable sheath for impermeably covering the first mould inner opening, said sheath stretching into the space towards the structure and retaining the structure in the spaced relationship when a retaining force for retaining the structure in spaced relationship is applied to said sheath, said sheath substantially smoothly aligning with the first mould inner surface to smoothly bound the space therewith when said retaining force is withdrawn for preventing a flow of the settable mixture outside the space through the first mould inner opening.

2. The spacer of claim 1, wherein said retaining force is applied by a retaining member being extendable from a retracted position, in which said retaining member is integrally retracted from the space through the first mould inner opening, to a retaining position in which said retaining member extends through the first mould inner opening into the space for applying said retaining force for retaining the structure in the spaced relationship, said sheath at all times covering said first mould inner opening and enveloping said retaining member when said retaining member is extended into the space in said retaining position.

3. The spacer of claim 2, wherein said sheath is comprised of rubber.

4. The spacer of claim 2 wherein said sheath is comprised of a flexible and impermeable polymer.

5. The spacer of claim 2, further comprising an extension means for extending said retaining member from said retracted position to said retaining position, said extension means extending from a retracted configuration when said retaining member is in said retracted position to an extended configuration when said retaining member is in said retaining position.

6. The spacer of claim 2, further comprising an adjustment means for selectively adjusting position of said retaining member in said space when in said retaining position.

7. The spacer of claim 2, further comprising a fastening means for securely and releasably fastening said spacer to a first mould outer surface of first mould, said first mould outer surface being disposed generally opposite the first mould inner surface.

8. The spacer of claim 5, wherein said extension means comprises an inflatable rubber bladder fixedly mounted in proximity to said retaining member, said bladder being in said retracted configuration when deflated and expanding therefrom into said extended configuration when inflated, said bladder thereby applying said retaining force, directed toward the structure, upon said retaining member for moving said retaining member into said retaining position and stretching said sheath into a stretched configuration, said retaining force being withdrawn when said bladder is deflated.

9. The spacer of claim 6, wherein said adjustment means comprises:
at least one axially movable rod having a first longitudinal rod end connected to said retaining member and a generally opposed second longitudinal rod end; and
a barrier means immovably and fixedly disposed upon said spacer, said rod being axially movably mounted therein between said retaining member on said first end and a stopper means mounted on said second end, said stopper means abuttingly engaging said barrier means when said retaining member is in said retaining position and stopping said retaining member from extending inwardly within the space beyond said retaining position, said stopper means being adjustably movable on said second rod end for adjusting said retaining position and thereby the spaced relationship.

10. The spacer of claim 7, wherein said fastening means comprises a fastening plate having a fastening plate inner surface, shaped to align with said first mould outer surface, and at least one notch for removably fastening said spacer to said first mould outer surface by securely fastening said notch between at least one fastening plate screw protruding outwardly from said first mould beyond said first mould outer surface and an adjustable threaded fastening plate nut and fastening plate washer disposed upon said fastening plate screw, said fastening plate washer being securely engaged upon said fastening plate by said fastening plate nut when said fastening plate is fastened to said first mould outer surface, said fastening plate being releasable by disengaging said fastening plate nut.

11. The spacer of claim 7, wherein said first mould outer surface comprises a first mould outer opening shaped and sized to be substantially aligned with the first mould inner opening, said retaining member being extendable through said first mould outer opening and the first mould inner opening into the space.

12. The spacer of claim 8, wherein said bladder comprises an inflation means for selectively introducing a substance for inflating said bladder to apply said retaining force upon said retaining member, and thereby to said sheath and to the structure, and for selectively releasing said substance for deflating said bladder, thereby withdrawing said retaining force, said inflation means being externally accessibly situated in said spacer within an externally accessible inflation means socket from which inflation means may be engaged for said introducing of said substance and said releasing of said substance.

13. The spacer of claim 12, wherein said substance is air and said inflation means comprises an air valve, said valve being selectively engageable in an open configuration, for said introducing and said releasing, and in a closed configuration for retaining said air within said bladder, said valve being removably connectable to an air pump for pumping said air therethrough when said pump is activated and said valve is in said open configuration for effecting said introducing, said air pump being deactivated and said valve engaged in said open configuration for effecting said releasing.

14. The spacer of claim 9, wherein said second rod end is threaded and said stopper means comprises a movably threaded adjustment nut having a retaining screw engaged in a retaining screw socket therein for securely and releasably retaining said adjustment nut in a selectively adjustable adjustment position corresponding to said retaining position when said adjustment nut is stopped by abuttingly engaging said barrier means, said adjustment nut being movable by at least partially disengaging said retaining screw from said retaining screw socket and by subsequently turning said adjustment nut.

15. The spacer of claim 9, further comprising a rod guiding means disposed within said barrier means for guiding said rod while moving through said barrier means and said spacer.

16. The spacer of claim 10, wherein said first mould outer surface comprises at least one protruding lip shaped for aligning with at least a portion of a corresponding edge of said fastening plate for facilitating alignment of said at least one notch with said at least one fastening plate screw.

17. The spacer of claim 10, wherein said first mould outer surface comprises an insert plate fixedly incorporated within the first mould and having an insert plate outer surface and an insert plate inner surface, said insert plate outer surface being shaped to align with said fastening plate inner surface and said fastening plate screws being disposed within said insert plate and extending outwardly from said insert plate outer surface for fastening of the fastening plate, said insert plate surface being smoothly shaped and aligning with the first mould inner surface, thereby further smoothly bounding the space with said inner surface and said sheath, said inner opening being disposed within said insert plate.

18. The spacer of claim 11, further comprising a back plate removably disposed in said first mould outer opening, said sheath being thereby securely attached between the first mould and said back plate, said back plate having a back plate opening through which said retaining member may pass and a back plate lower surface shaped to engage said sheath for smoothly aligning a sheath inner surface thereof with the first mould inner surface.

19. The spacer of claim 15, wherein said guiding means comprises a rod guide socket in axial alignment with a rod opening disposed in said barrier means, said rod being axially movably mounted through said rod opening and said rod guide socket, said rod guide socket being shaped and sized for maintaining said rod in movable axial alignment with said rod opening when said rod is moved through said rod guide socket.

20. A stretchable sheath disposed between a retaining member of a spacer and an first mould inner opening of a first mould inner surface of a first mould mould, the first mould inner opening being impermeably covered by said sheath and extending at least partially inwardly into the first mould, said sheath stretching and enveloping said retaining member when said retaining member is extended through the first mould inner opening into a retaining position for retaining a structure in a spaced relationship relative to the first mould inner surface during distribution of a settable mixture within a space within the first mould, said sheath being substantially aligned with the first mould inner surface and smoothly bounding the space therewith when said retaining member is integrally retracted from the space into a retracted position, said sheath preventing a flow of the settable mixture outside the space through the first mould inner opening.

21. A method for preventing flow of a settable mixture outside of a space within which a settable mixture is distributed while maintaining a spaced relationship of a structure relative to a first mould inner surface of a first mould which has a first mould inner opening extending at least partially into the first mould, said method comprising the steps of:
a) securely attaching a stretchable sheath to the first mould to impermeably cover the first mould inner opening;
b) subsequent to said attaching, extending a retaining member through the first mould inner opening into a retaining position to retain the structure in the spaced relationship;
c) subsequent to said extending, distributing the settable mixture within the space; and
d) before terminating said distributing, retracting said retaining member from the space into a retracted position outside the space, said sheath being smoothly aligned with the first mould inner surface and smoothly bounding the space therewith when said retaining member is in said retracted position, said sheath preventing a flow of the settable mixture outside the space through the first mould inner opening.
